(19) United States
(12) Patent Application Publication
(10) Pub. No.: US 2012/0246679 A1
(43) Pub. Date: Sep. 27, 2012

(54) Method and Apparatus for Initiating and Executing a Joint Viewing Session of a Programming Event

(75) Inventor: Mi Chen, Aurora, CO (US)

(73) Assignee: EchoStar Technologies L.L.C., Englewood, CO (US)

(21) Appl. No.: 13/070,993

(22) Filed: Mar. 24, 2011

(51) Int. Cl. H04N 5/445

(52) U.S. Cl. 725/38

(57) ABSTRACT

Various mechanisms for initiating and/or executing a joint viewing session across a network are disclosed herein. A first user may provide an instruction to an entertainment device to send an invitation to a remote device corresponding to a second user, requesting that the second user participate in a joint viewing session of a programming event. A calendar event may be added to a calendar application at the entertainment and/or the remote device. In some embodiments, during the joint session, the programming event may be simultaneously presented at both the entertainment device and the remote device. A communications session may be established between the entertainment device and the remote device, and communications from the first user may be transmitted from the first entertainment device to the remote device for presentation to the second user during the joint viewing session.

### BACKGROUND

Watching television is often a social experience. Groups of people will sometimes gather at a group member's home, or at a public location (e.g., a bar), in order to watch a television program together. For example, during seasons of the hit ABC television show, LOST, groups of people around the United States would gather together weekly when a new LOST episode was scheduled to air in order to view the show, discuss the intriguing plot developments that week, consume food and beverages, and socialize. This phenomenon is not unique to LOST. Social television-watching gatherings often occur to view episodes of television shows, airings of movies, sporting events such as the SUPER BOWL, or to view pay-per-view events such as an ULTIMATE FIGHTING CHAMPIONSHIP event.

In recent years, entertainment devices for receiving and presenting television signals have become increasingly more advanced in order to provide users with new features that enhance their viewing experience. Digital Video Recording (“DVR”) technology has become widely adopted in devices that receive television programming. DVRs enable users to record programming received from television providers in order to watch the programming at a later time and typically permit the user to skip forward and backward while watching recorded programming. In order to plan future viewing schedules or set up DVR recording schedules, users of modern television entertainment devices can often browse and interact with an Electronic Programming Guide (“EPG”) presented by their entertainment device. Additionally, many recent television entertainment devices may be connected to the internet, enabling new types of services to be provided to users, and allowing for connections and interactions between users via their television entertainment devices.

### BRIEF DESCRIPTION OF THE DRAWINGS

The same number represents the same element or same type of element in all drawings.

FIG. 1A illustrates an embodiment of a video content distribution environment.

FIG. 1B illustrates an embodiment of a video content distribution environment having multiple entertainment devices.

FIG. 2 illustrates an embodiment of an entertainment device.

FIG. 3A depicts a virtual joint viewing session according to one embodiment.

FIG. 3B depicts a second virtual joint viewing session with multiple participants, from the perspective of a first participant, according to one embodiment.

FIG. 4 illustrates a process for conducting a joint viewing session.

### DETAILED DESCRIPTION

The various embodiments described herein generally provide apparatuses, systems and methods for initiating and/or executing a joint viewing session across a network. More particularly, described herein are techniques for sending an invitation from a user of an entertainment device to one or more users of other devices in order to facilitate a joint viewing session of a programming event. In some implementations, the invitation may be an invitation for the other persons to join the user of the entertainment device to view the programming event at the same location at a specified time. In at least one embodiment, a calendar event corresponding to the joint viewing session may be set at the entertainment device and/or at a device that receives an invitation. However, in at least one implementation, a virtual joint viewing session may be established, wherein communications are relayed between entertainment devices of users that are simultaneously watching a programming event at different locations.

In at least one embodiment, an entertainment device may include a presentation interface, which presents a graphical representation of a programming schedule for a plurality of programming events that are scheduled to be broadcast in the future. The entertainment device may also provide a user input interface that receives a selection of a programming event and a viewing time from the user via an input device. A processor of the entertainment device may set a calendar event corresponding to the viewing time for presenting the programming event. A communications interface of the entertainment device may then send an invitation to a second device corresponding to a second user, wherein the invitation includes scheduling information for a viewing time for the selected programming event and includes a request for the user of the second device to participate in a viewing session of the programming event with the user of the entertainment device at the viewing time. A processor of the remote device may set a calendar event corresponding to the viewing time.

In at least one embodiment, facilitating a joint viewing session may involve receiving, at a first entertainment device, a user input from a first user instructing the entertainment device to transmit an invitation to a second entertainment device, which corresponds to a second user. The invitation may be associated with a programming event. The first entertainment device may transmit the invitation to the second entertainment device. Subsequently, the first entertainment device receives a broadcast of the first programming event. The first entertainment device presents the programming event at a corresponding display device. In at least one embodiment, the programming event is presented simultaneously with a presentation of the programming event by the second entertainment device at a second display device. The first entertainment device may establish a communications session with the second entertainment device during the presentation of the programming event. During the communication session, the first entertainment device may receive an input of a plurality of communications from the first user. The first entertainment device may then transmit the received communications to the second entertainment device, for presentation thereon during the presentation of the programming event, in order to facilitate a virtual joint viewing session.

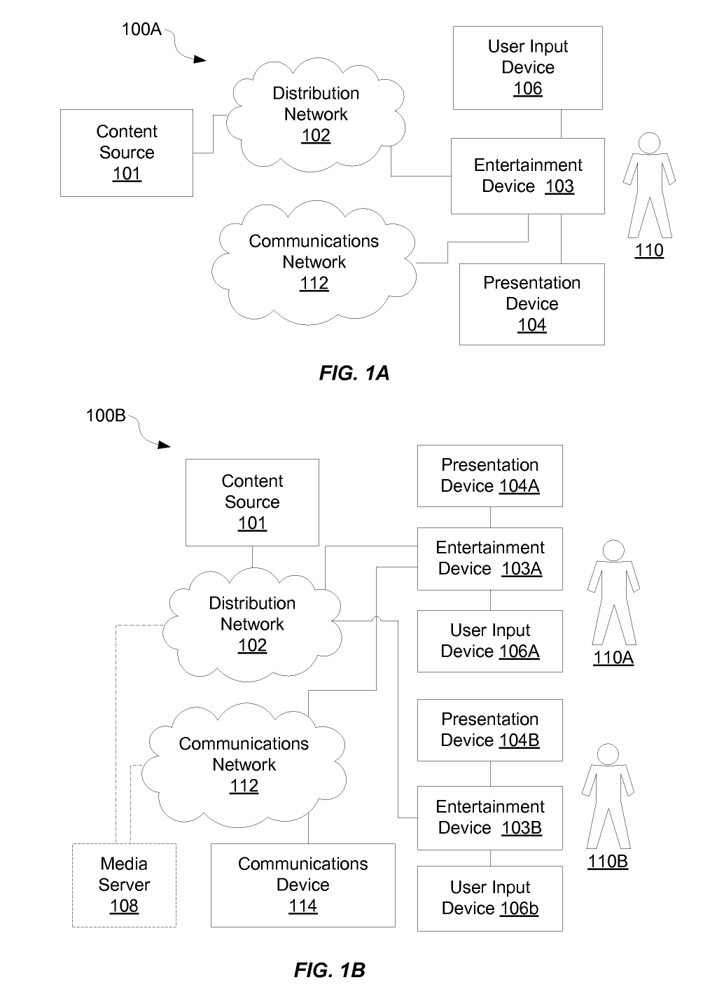

FIG. 1A illustrates an embodiment of a video content distribution environment 100A. The content distribution environment 100A includes a content source 101, a distribution network 102, a communications network 112, an entertainment device 103, a user input device 106, and a presentation device 104. The content distribution environment 100A, and each of the depicted components of the distribution environment 100A, may include other components, elements or devices not illustrated herein.

The content source 101 is operable for receiving, generating and/or communicating content to one or more entertainment devices 103 via the distribution network 102. The content to be received, processed, outputted and/or communicated by the content source 101 may come in any of various forms including, but not limited to, audio, video, audio/video, text, data, or otherwise. In at least one embodiment, the content source 101 is operable for receiving various forms and types of content from other sources, aggregating the content and transmitting the content to the entertainment device 103 through the distribution network 102. For example, the content source 101 may be a satellite, cable, or fiber-optic television provider, which aggregates and distributes television content from various sources. In some embodiments, content source 101 may be a non-aggregating content provider, for example, an over-the-air (“OTA”) broadcast station for a television channel. It is to be appreciated that the content source 101 may receive and/or transmit practically any form and/or type of information from one or more sources including streaming television programming, recorded audio or video, electronic programming guide data and the like. In at least one embodiment, the content source 101 may be embodied as a transmission facility of the distribution network 102. Exemplary content sources 101 include OTA terrestrial transmission facilities, cable television distribution head-ends, satellite television uplink centers, broadband or internet servers and the like.

The distribution network 102 is operable to transmit content from the content source 101 to the entertainment device 103. The distribution network 102 may comprise any type of wired (e.g., cable and fiber) and/or wireless (e.g., cellular, satellite, microwave, and other types of radio frequency) communication medium and any desired network topology (or topologies when multiple mediums are utilized). Exemplary distribution networks 102 include terrestrial, cable, satellite, fiber-optic, and internet protocol television (IPTV) distribution systems. In at least one embodiment, the content source 101 broadcasts or multicasts content to a plurality of television receivers, e.g., entertainment device 103, via the distribution network 102. The content source 101 may also distribute content via the distribution network 102 that is specifically targeted to an addressable television receiver, e.g., entertainment device 103, such as video-on-demand content and the like.

The content distribution environment 100A includes a communications network 112. In at least one embodiment, communications network 112 comprises a data communications network, such as the internet. In various embodiments, communications network 112 may be implemented through a public switched telephone network (PSTN), LAN, WAN, or other wired (including fiber, cable, DSL, ISDN, T1, and the like) or wireless (including microwave, radio frequency, Wi-Fi, WiMax, cellular, and the like) network or combination thereof. Content source 101 may, in some embodiments, be connected to communications network 112 and provide additional data to entertainment device 103 via the communications network, such as on-demand data. Entertainment device 103 may receive and transmit other data to and from one or more servers via communications network 112, such as programming information data, system health data, software updates, internet browsing data, joint viewing session invitations and communications, and so forth. Entertainment device 103 may also communicate to other similar entertainment devices and/or with other communications devices via the communications network 112. In some embodiments, communications network 112 and distribution network 102 may be the same logical and/or physical network.

The entertainment device 103 is operable to receive content from the distribution network 102 and output the content for presentation by the presentation device 104. For example, the entertainment device 103 may receive content in a live viewing mode and perform appropriate processing to format the content for simultaneous presentation by the presentation device 104. The entertainment device 103 may also have DVR functionality and be operable to store received content in non-volatile memory for subsequent presentation to the user 110 at the presentation device 104.

In at least one embodiment, the presentation device 104 is a display device (e.g., a television) configured to display content to a user 110. In another embodiment, the presentation device 104 comprises an audio receiver (e.g., a stereo, speaker system, headphones or the like) operable to output audio content. The entertainment device 103 may receive an audio, video or audio/video stream in any format (e.g., analog or digital format), and store and output the associated content for presentation by the presentation device 104. Exemplary audio/video formats include Motion Picture Experts Group (MPEG) standards, Flash, Windows Media and the like. While the techniques illustrated herein are described in the context of reception of an audio/video stream, it is to be appreciated that the techniques may also be applied to the processing and output of other types of media content, such as audio streams or video streams, by any type of receiving device, including an audio receiver, a video receiver or any audio/video receiver.

As used herein, an entertainment device 103 may in some implementations also be referred to as a set-top box, which is a television receiver that is located externally with respect to a display device. However, in some implementations, the entertainment device 103 and the presentation device 104 may be integrated as a single device combining the functionality of a display device and a receiver/DVR or the like.

The entertainment device 103 may be further configured to output menus and other information to presentation 104 that allow a user 110 to control the output of audio/video content by the entertainment device 103, view and select programming from electronic programming guides (EPG's), set recording timers and the like. User 110 may interact with entertainment device 103 and/or presentation device 104 with one or more user input devices 106, which may be, for example, a remote control.

In at least one embodiment, responsive to the user 110 setting particular recording timers, the entertainment device 103 functions as a DVR and coordinates the reception of audio/video signals associated with a television program through a television receiving resource (e.g., a tuner) and storage of the video signal onto a storage medium (e.g., a hard drive or Flash memory). The entertainment device 103 may also record content currently being broadcast and viewed (e.g., the user 110 presses a record button on a remote control while watching television). In some embodiments, the entertainment device 103 may include multiple television receiving resources to record or present multiple television programs simultaneously. In embodiments with DVR functionality, the entertainment device 103 outputs a recorded audio/video stream to the presentation device 104 for presentation to a user 110 responsive to a request to play back recorded content.

In some embodiments, entertainment device 103 receives EPG data, which includes scheduling information regarding available programming, from content source 101 or another source via distribution network 102 or communications network 112. EPG data may be browsed via a user interface presented at the presentation device 104, and a user 110 may select programming to watch and/or to record at the entertainment device 103. Displayable programming information may include information about program title, actors, ratings data, episode numbers, a brief description of the program, and so forth. Some EPG implementations permit a user 110 to zoom or focus on a particular program or time slot to view extended data. In at least one embodiment, a user 110 may browse EPG data for future programs and select the events to schedule for recording. Recording timers may be set to record a single instance of a program, or may be set as recurring timers to recurrently record related programs, such as episodes of a series. In some embodiments described in more detail below, an EPG may be used by a user to create and send an invitation to a user of a remote device to join a joint viewing session, and a corresponding schedule of joint viewing sessions may be displayed in an EPG. An EPG may correspond to a calendar application, which may provide a view of upcoming scheduled events. A calendar application may provide a view of scheduled recordings and/or of scheduled joint viewing sessions.

Content distribution environment 100A further includes a user input device 106 coupled to the presentation device. As used herein, a user input device may comprise a remote control, a keyboard, a digital video camera, a digital microphone, or other peripheral device for providing input to entertainment device 103. Although just one user input device 106 is depicted, it is to be understood that multiple user input devices may be configured to communicate, either wirelessly or with a wired connection, to the entertainment device. Some input devices may combine the functionality of several different user input devices. In at least one embodiment, a user input device comprises a cell phone, smart phone, PDA, tablet, or other mobile computing device that is configured to communicate via a wired or wireless communication session with the entertainment device, via any of various communications protocols and/or technologies that are known in the art (e.g., TCP/IP, Bluetooth, etc.).

FIG. 1B depicts a content distribution environment 100B that includes a content source 101, distribution network 102, and communications network 112, all of which correspond to the similarly numbered elements of FIG. 1A, as described above. Content distribution environment 100B also includes several entertainment devices 103A and 103B, with associated users 110A and 110B, presentation devices 104A and 104B, and user input devices 106A and 106B. In various embodiments, entertainment devices 103A and 103B—and corresponding user input devices 106A and 106B and presentation devices 104A and 104B—may have the characteristics described above with respect to corresponding devices 103, 106 and 104 of FIG. 1A, or may have a subset of those described features and/or additional features. It is noted that entertainment devices 103A and 103B (and corresponding user input devices and presentation devices) do not need to be identical devices or have identical features or capabilities in order to be compatible with one or more of the features claimed or described herein. It is further noted that in a distribution environment similar to that illustrated in FIG. 1B, there may be many more than two entertainment devices that are connected to a content source 101 via distribution network 102 and interconnected via a communications network 112; the functionalities described herein are designed to scale across more than just two entertainment devices.

In at least one embodiment, a user input is received at entertainment device 103A from the first user input device 106A. The user input may be from the first user 110A and instruct the entertainment device 103A to transmit an invitation for a joint viewing session to a remote device. In some embodiments, remote device may be the second entertainment device 103B, which corresponds to a second user 110B. In other embodiments, the remote device may be communications device 114, which may be, for example, a cell phone, smart phone, PDA, tablet computer, laptop, or a personal computer associated with the second user 110B. The invitation is transmitted via communications network 112. In at least one embodiment, the remote device may be located in a geographically separate (i.e., geographically remote) location with respect to entertainment device 103A. The invitation that is sent by the user 110A via entertainment device 103A to the remote device to join a joint viewing session is associated with a programming event. Specifically, in some embodiments, the invitation may correspond to a programming event that is scheduled to be broadcast to the entertainment device 103A during a specifically scheduled future time slot. The user may browse programming events using an EPG interface displayed by the entertainment device 103A, and select a programming event to be associated with the invitation to a joint viewing session, to be sent to the remote device. In some embodiments, the user may specify a future viewing time for a joint viewing session corresponding to the invitation. In some embodiments, the viewing time may be a scheduled broadcast time for the programming event, but in some embodiments, the viewing time may be a later time than the scheduled broadcast time. When a viewing time for a joint viewing session is later than a scheduled broadcast time, the joint viewing session may be facilitated by the entertainment device 103A recording the programming event via DVR functionality and playing back the recorded programming event at the viewing time.

In at least one embodiment, when a user 110A selects a programming event for a future joint viewing session at a future viewing time, a processor of the entertainment device 103A may set a calendar item at the entertainment device, which corresponds to the viewing time. A calendar item may be displayable in a calendar software application, which in some embodiments, may be displayed in conjunction with an EPG. Addition information may also be associated with the calendar item for a planned joint viewing session, for example, a list of invitees, a length of time of the viewing session, a location for the viewing session, and so forth.

In at least one embodiment, an invitation may be an invitation for the second user 110B to join the first user 110A for a joint viewing session of the programming event, in person at the location of the first entertainment device 103A at a corresponding viewing time. The invitation may be transmitted to the second user 110B as a message. In some embodiments, a message may be a simple email or textual message. In at least one embodiment, a message sent by an entertainment device 103A to a remote device corresponding to an invitation to a joint viewing event may be operable to be processed by a remote device in order to schedule a calendar event (i.e. calendar item) at the remote device at the viewing time. A calendar event may have one or more additional information associated with it, for example, a list of invitees, a length of time of the viewing session, a location for the viewing session, a length of time for the viewing session, or even a food assignment or discussion topic in some implementations. Calendar events may trigger reminders, alarms, or other events at the remote device.

In one implementation, an invitation to a joint viewing session sent by entertainment device 103A may be presented to the user 110B at the remote device, and the user 110B may accept or decline the invitation. If the user 110B accepts the invitation, then the viewing session corresponding to the programming event may be scheduled in a calendar application of the remote device. In at least one embodiment, a subsequent reminder may be presented to the user when a scheduled viewing session is approaching. As described below, in at least one embodiment, the remote device may be a second entertainment device 103B. In some implementations, entertainment device 103B may be configured to automatically schedule joint viewing sessions into a calendar associated with an EPG when invitations to joint viewing sessions are received.

In some embodiments, where the remote device is the second entertainment device 103B, the invitation may be an invitation for the second user 110B to share a “virtual” joint viewing session of the programming event with the first user 110A at a specified time. In a virtual joint viewing session, a broadcast of the programming event is received at both the first entertainment device 103A and the second entertainment device 103B. The programming event is presented by the entertainment device 103A at the first presentation device 104A simultaneously (i.e. synchronously) with a presentation of the programming event by the second entertainment device 103B at the second presentation device 104B. A viewing time for the joint viewing session may be specified in the invitation sent from the first entertainment device 103A to the second device 103B. The first and second entertainment devices may process the invitation in order to simultaneously schedule a presentation of the programming event at the viewing time. A virtual joint viewing session may potentially involve many more than just two entertainment devices, with the joint viewing session involving multiple devices implemented according to techniques described herein.

During a simultaneous presentation of a programming event in a virtual joint viewing session, a communications session may be established between a first entertainment device 103A and a second entertainment device 103B via the communications network 112. The communications session may use any of many communications protocols known in the art, which are suitable for transmitting communications between the two devices in real-time or near real-time. Examples of communications protocols include but are not limited to UDP, TCP/IP, any of various video and/or audio transmission protocols, voice-over-IP protocols, and/or other protocols that facilitate transmission of communications (e.g., SKYPE's proprietary protocol(s) for transmitting voice, text and/or video between network nodes), including combinations and derivatives of such protocols. During the joint viewing session, while the programming event is being presented at both entertainment devices, the first entertainment device 103A may receive an input of a plurality of communications from the user 110A via the user input device(s) 106A. As discussed above, user input devices may include remote controls, keyboards, microphones, video cameras, or other input devices and combinations thereof. Communications may be textual, audio and/or video. The communications that are received at the first entertainment device 103A from the user 110A are transmitted to the second entertainment device 103B via the communications session and presented in real-time or near real-time simultaneously as the second device 103B continues presenting the programming event during the joint viewing session. Likewise, in some embodiments, communications may be received from the second user 110B via the user input device(s) 106B that are connected to the first entertainment device 103B, and transmitted from entertainment device 103B to entertainment device 103A for presentation to the first user 110A during the joint viewing session.

In at least one embodiment, an invitation that is sent from one entertainment device 103A to another entertainment device 103B may be an invitation to simultaneously watch the corresponding programming event in a virtual joint viewing session at the time that the programming event is aired, i.e., “live.” In such implementations, receiving resources of both first and second entertainment devices 103A and 103B may be simultaneously tuned (automatically, or otherwise) to a broadcast of the programming event in order to simultaneously present the event to the first and second users 110A and 110B. A corresponding communication session may be established in conjunction with the simultaneous presentation of the programming event corresponding to the viewing session, as described in the previous paragraph, in order to facilitate the communications involved in a virtual joint viewing session.

On the other hand, in at least one embodiment, a user may invite another user to participate in a joint viewing session of a recorded or to-be-recorded programming event. Because the viewing session corresponds to a recorded or to-be-recorded event, a viewing time for the viewing session may be at any time after the programming event has been recorded at the entertainment devices involved in the joint viewing session. For example, a user may send an invitation from a first entertainment device 103A to a second entertainment device 103B, inviting the second device's user to participate in a virtual joint viewing session of a to-be-recorded program at a specified viewing time. Upon the second entertainment device 103B receiving and processing the invitation, a joint viewing session may be scheduled at the two boxes at the viewing time. In order to facilitate the virtual joint viewing session, recording timers are set at both entertainment devices to record the programming event at a time or times when the programming event is scheduled to be broadcast. The recording time will not necessarily coincide with the viewing time for the joint viewing session; the viewing time may be some time after the recording time. Once the viewing time for the joint viewing session of the recorded program arrives, both first and second entertainment devices 103A and 103B may provide playback of the recorded program, and communication sessions may be established in order for the users 110A and 110B to experience the joint viewing session and communicate thereby.

In at least one embodiment, reminders may be provided to the user when the time for the joint viewing session is drawing near, for example by an alert presented by an entertainment device, notifications within EPG presentation, by text message, email, and so forth. In embodiments where the remote comprises a second entertainment device 110B, recording timers and/or presentation timers may be automatically set in order to facilitate a virtual joint viewing session.

In at least one embodiment, a remote device that is configured to receive invitations to joint viewing sessions may or may not be configured to also send invitations. In one implementation, a device may receive invitations and set calendar events or provide information corresponding to an invitation to a joint viewing session to a user of the remote device. The remote device may be a communications device 114, as described elsewhere herein. As an example, a sports bar may have an entertainment device which is configured to send invitations to a number of remote devices, inviting their users to participate in a joint viewing session of a programming event at the sports bar. The remote devices may, in this example, be entertainment devices or may be other communications devices as defined elsewhere herein. The users of the remote devices may have subscribed or signed up to receive invitations from the sports bar. In some implementations of this example, a user may accept or decline (or not act at all) on an invitation. In the case that a user accepts the invitation to the event, a calendar item may be added to the user's device and, optionally, a reminder may be provided to the user when a time corresponding to the event arrives and/or a response may be provided to the device at the sports bar. This example may apply to other events at other types of locations, for example, homes, sporting events, religious events, discussion groups, and so forth.

In at least one embodiment, an entertainment device may be configured to receive communications from another entertainment device during a virtual joint viewing session but may or may not be configured to also send communications. As an example, an entity or person may provide an invitation to a number of entertainment devices of users to participate in a virtual joint viewing session. The entity, for example, could be a musical group that will be hosting a viewing session of a concert. Participants who are invited to participate in the joint viewing session may view the event at their own entertainment device, and receive communications from the musical group live, as the joint viewing session is carried out. In some embodiments, the invitees may also input communications to their entertainment device, which are communicated to other invitees and/or the host of the session.

FIG. 1B also depicts a media server 108, illustrated with dashed lines to indicate that it is optional and not included in all embodiments. In at least one embodiment, media server 108 may facilitate and provide functionality for a virtual joint viewing session. The media server 108 may receive a request from a user 110A to host a joint viewing session corresponding to a programming event. The user 110A may then, via either the media server 108 or entertainment device 103A, send invitations to other users' entertainment devices (e.g., entertainment device 103B) to participate in the joint viewing session at a particular time. In at least one embodiment, the media server may receive a transmission of the programming event and retransmit the event to entertainment devices 103A and 103B during the joint viewing session. In one implementation, the programming event is recorded by the media server for subsequent retransmission to participating entertainment devices. The media server 108 may facilitate communications between the entertainment devices that are participating in the joint viewing session, relaying communications from the devices' respective users therebetween. However, in at least one embodiment, entertainment devices receive and present the programming event(s) corresponding to a joint viewing session, and the media server 108 acts as a relay for communications between participating entertainment devices during the joint viewing session.

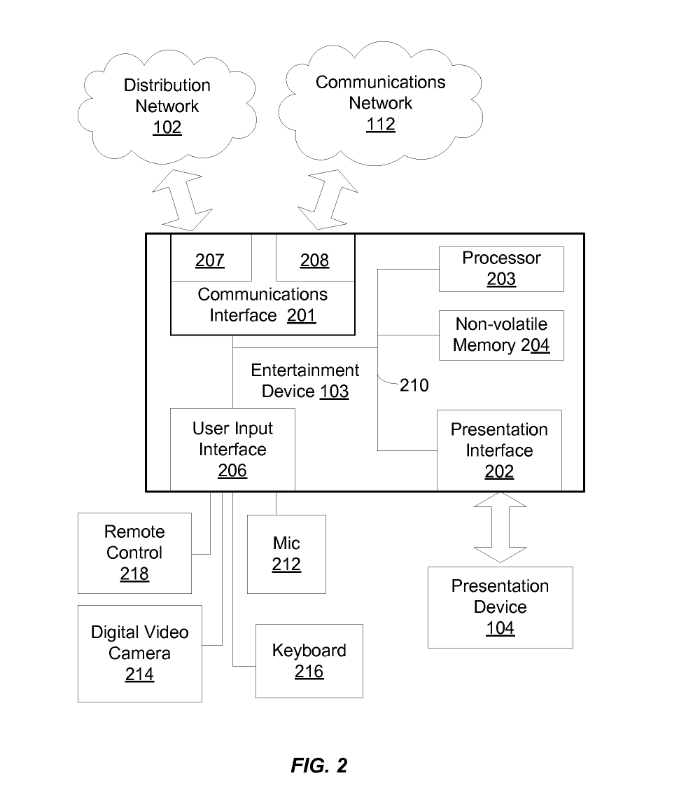

FIG. 2 depicts an embodiment of an entertainment device 103, which will be discussed in context of the content distribution environments 100A and/or 100B discussed above. In at least one embodiment, entertainment device 103 is a set top box, as described above. Entertainment device 103 includes a communications interface 201, presentation interface 202, processor 203, non-volatile memory 204, and user input interface 206. FIG. 2 is merely an illustration of an embodiment of an entertainment device 103, and it is understood that the components thereof may be implemented either functionally or logically, as hardware or as software, and may be integrated into consolidated units or separated into multiple units beyond what is depicted in the example embodiment shown in FIG. 2. Further, entertainment device 103 may include additional components beyond those depicted in FIG. 2. The various components of entertainment device 103 are depicted as being connected via a bus 210. The bus 210 and the connections thereto that are depicted in FIG. 2 are merely illustrative; the components of the entertainment device 103 may be connected in any of several configurations using any number of buses or other connections.

Entertainment device includes a processor 203. The processor 203 is configured to process data received via the communications interface 201. In some embodiments, processor may be configured to demodulate, decrypt, and/or decode video data received from distribution network 102 in order to provide a video stream in a displayable format to the presentation interface 202 for display on presentation device 104. Processor 203 may also be configured to process one or more incoming video streams and coordinate storage of the video streams into the non-volatile memory 204 for later viewing.

Entertainment device 103 includes a user input interface 206 which is configured to receive commands from a user 110. Commands may be input by a user 110 via input devices. Various exemplary input devices are depicted in FIG. 2, which may correspond to input device 106 of FIG. 1A. The depicted exemplary input devices include a microphone 212 that captures audio, a digital video camera 214 that captures video 110, a keyboard for receiving textual input from the user 110, and a remote control 218. It is to be understood that the various input devices depicted in FIG. 2 are for illustrative purposes only, and that any number, combination, or type of input devices (whether depicted or not depicted) may be used to provide user inputs to entertainment device 103 when such input device(s) are properly configured and operable to provide such inputs. Input devices may provide input to entertainment device 103 either wirelessly (e.g., via infrared or radio frequency) or through any type of wired connection and corresponding protocol(s) that are known in the art.

User input interface 206 may receive one or more user inputs from a first user instructing the entertainment device 103 to transmit an invitation to a joint viewing session, corresponding to a programming event, to a second entertainment device. In at least one embodiment, the second entertainment device is in a location that is geographically remote from the first entertainment device. The invitation may be a request for a user of the second entertainment device to join the first user in a joint viewing session.

Entertainment device 103 includes a communications interface 201. Communications interface 201 includes a television receiving interface 207 and a network interface 208. Television receiving interface 207 communicates with distribution network 102 to receive content, including programming content, and other data from a content source. Network interface 208 is connected to communications network 112 (e.g., the internet). The communications interface 201—particularly, the network interface 208—may transmit the invitation to a joint viewing session via the communications network 112 to the second entertainment device corresponding to the second user. Once a viewing session between two or more users is scheduled, the television receiving interface 207 may receive a transmission of the corresponding programming event from content source 101 via the distribution network 102.

Processor 203 of the entertainment device 103 may be configured to schedule a calendar item associated with an invitation to a joint viewing session that is either sent or received. In some embodiments, entertainment device 103 may be configured to receive invitations to joint viewing sessions from one or more other entertainment devices, but may or may not be configured to send such invitations.

Entertainment device 103 further includes a presentation interface 202, which outputs streams of video and/or audio data for presentation on presentation device 104. The presentation interface 202 may present the programming event corresponding to the joint viewing session. As discussed above, the programming event may be presented simultaneously as it is received (i.e., live), or it may be recorded by a DVR device in non-volatile memory 204 and presented at the presentation interface 202 at a subsequent viewing time corresponding to the invitation and the viewing session. In at least one embodiment, the entertainment device 103 may automatically initiate presentation of the programming event at the viewing time corresponding to the joint viewing session. As an example, a day-time programming event may be recorded by one or more entertainment devices participating in a joint viewing session when it is broadcast and then played back by the devices in a joint viewing session at a scheduled viewing time that evening.

In at least one embodiment, during presentation of the programming event at a viewing time corresponding to the viewing session, the user input interface 206 receives a plurality of communications from the user 110 of the entertainment device 103. As examples, commands may be input via remote control 218; textual input may be input via a keyboard 216; video of a user may be captured and input by digital video camera 214; and/or audio from the user may be received by the microphone 212; all of which may be input to the user input interface 206. As communications are received, they are transmitted to the second entertainment device by the communications interface 201—specifically, the network interface 208—via communications network 112. The communications are transmitted synchronously during at least a portion of the presentation of the programming event corresponding to the joint viewing session. In at least one embodiment, communications are also received from the second entertainment device via the communications interface 201 during the joint viewing session. Communications that are received from the second entertainment device may be presented to the user 110 by the presentation interface 202.

In at least one embodiment, presentation interface 202 may present an EPG to a user, i.e., a graphical representation of programming schedule information corresponding to future programming events that are scheduled to be broadcast at future times via the distribution network 102. The user input interface 206 may receive a selection from a connected input device (e.g., keyboard 216, remote control 218, or other input device, such as a smart phone, PDA, tablet, etc.). The selection may correspond to a future programming event selected from the EPG. The user input interface 206 may receive a corresponding input instructing the device to send an invitation to a remote device that is associated with a second user. As described elsewhere herein, the remote device may be a second entertainment device, or it may be another type of communications device such as a smart phone, tablet device, PDA, laptop, other computing device, and so forth. The invitation is transmitted to by the communications interface 201 to the remote device. The invitation corresponds to the selected programming event and may specify a time slot or viewing time when the first user is requesting that the second user join the first user for a joint viewing session of the programming event. Subsequently, the receiving interface receives a transmission of the programming event during a scheduled broadcast time. Then, the presentation interface presents the programming event at the viewing time for the joint viewing session, which may correspond to the broadcast time or may be a subsequent time when the programming event is played back by a DVR.

In one implementation of the embodiment described in the previous paragraph, the invitation may comprise an invitation for the second user to view the programming event at a particular time with the first user at the location of the entertainment device 103 (i.e., in person). In another implementation, the invitation may correspond to a virtual joint viewing session involving two or more entertainment devices synchronously presenting the programming event and providing communications therebetween of the devices' respective users, as described herein.

In at least one embodiment, an invitation may be operable to cause a scheduling or calendar application of the remote device to schedule the viewing session. A processor may process the invitation to create a calendar event at the remote device. For example, a second entertainment device, which may or may not be operable to also send invitations to joint viewing sessions, may receive the invitation and schedule a reminder for the viewing session, create a calendar entry for the viewing session, or provide for recording and presentation timers to facilitate the viewing session. In another example, the invitation may be received at a calendar or scheduling application of a remote device, and cause that the remote viewing session be added to the second user's calendar application that may include other appointments and/or meetings.

Although the implementations described herein are discussed in terms of two entertainment devices and two users, it is understood that a joint viewing session may involve multiple users and/or multiple devices. As such, an invitation may be sent from one user to a plurality of other users in order to facilitate a joint viewing session amongst all of the users.

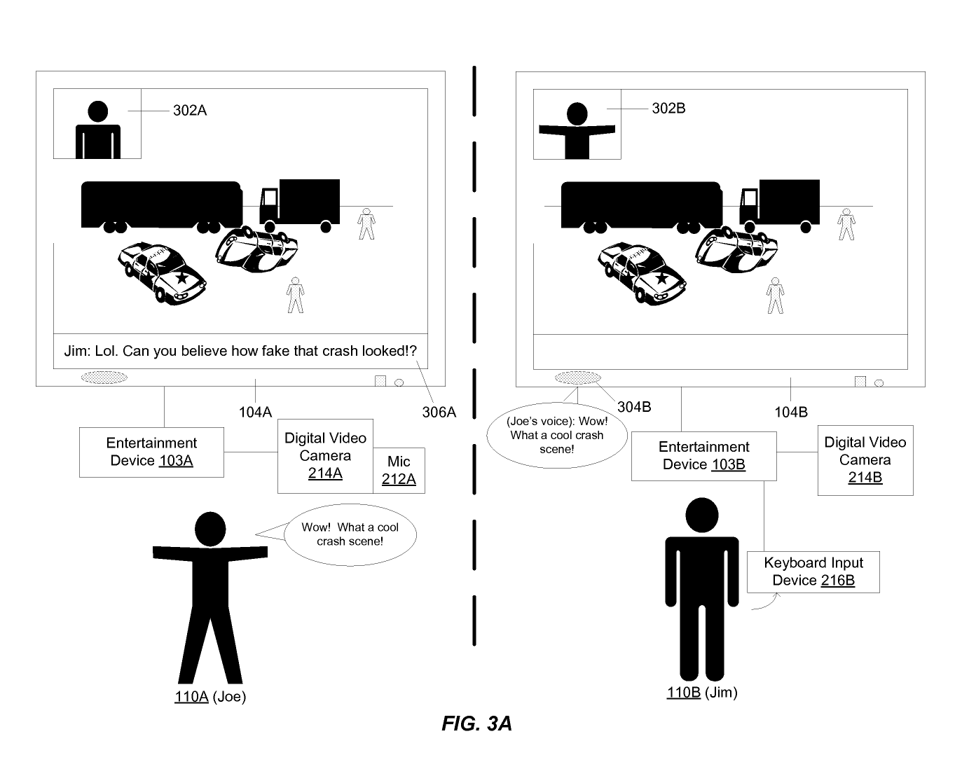

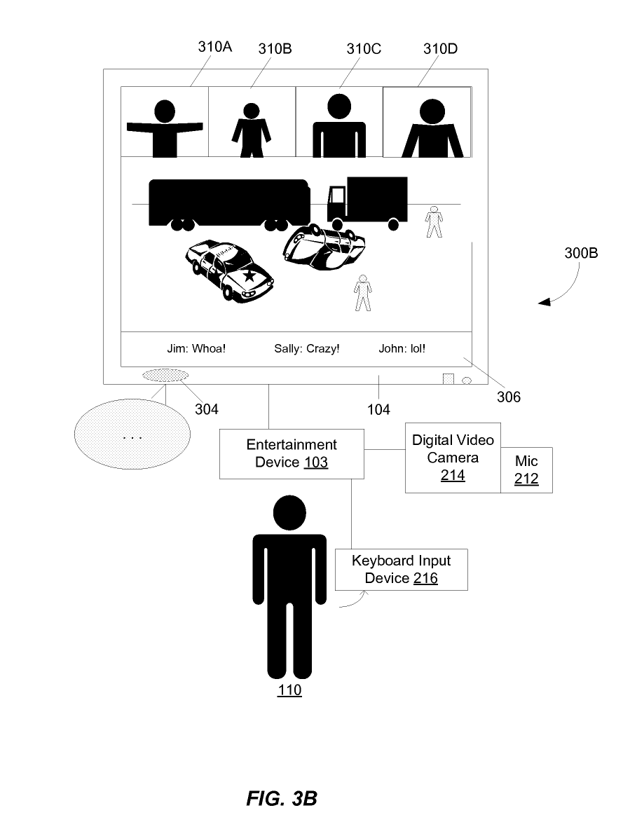

FIG. 3A provides an illustration of a virtual joint viewing session between two users 110A and 110B of two entertainment devices 103A and 103B. The entertainment devices may be in separate locations, as indicated by the large dashed line. A single programming event may be simultaneously presented by each entertainment device 103A and 103B on corresponding display devices 104A and 104B during a virtual joint viewing session.

During the joint viewing session, communications of each user may be captured by various input devices and transmitted to the entertainment device corresponding to the other user. For example, as both user 110A (“Joe”) and user 110B (“Jim”) watch a scene of the same programming event, input devices corresponding to device 103A—a digital video camera 214A and a microphone 212A—capture user 110A's reactions to the scene. These inputs are communicated by entertainment device 103A to entertainment device 103B via a communications session corresponding to the virtual joint viewing session. The video captured by the video camera 214A is then displayed by entertainment device 103B on presentation device 104B in a display frame 302B. Audio input from the first user 110A, input into microphone 212A, is similarly transmitted to entertainment device 103B and presented to user 110B via an audio speaker 304B. Similarly, the reactions of user 110B are input to entertainment device 103B via digital video camera 214B and keyboard input device 216B. The inputs are communicated via the communications session from entertainment device 103B to entertainment device 103A. The captured video is then displayed at user 110A′s presentation device in a display frame 302A, and the textual data input via keyboard 216B from user 110B is presented to user 110A in a ticker window 306A. Text may displayed in other formats or modes which are suitable for overlaying the text over the ongoing video presentation, or for presenting the text therewith.

FIG. 3B illustrates an example of an entertainment system 300B corresponding to a user 110, who is engaged in a virtual joint viewing session with four other persons. As depicted therein, various input devices, including digital video camera 214, microphone 212, and keyboard input device 216, receive communication inputs from the user 110 and provide the communications to the entertainment device 103, which transmits the communications to other participants of the joint viewing session. At the same time, the entertainment device 103 receives communications from the other participants in the joint viewing session and presents these inputs as follows: in the various video feed frames 310A-D for video communications received from the other four users, via speaker 304 for audio communications received from the other four users, and via a textual presentation frame 306 for textual communications.

It is to be understood that the presentation formats and modes depicted in FIGS. 3A and 3B and the input devices depicted therein are merely examples. Video data, audio data, and textual data may be presented in various manners and via various graphical arrangements by entertainment devices and presentation devices, and various configurations of input devices may be configured at each unique entertainment device to receive user input. In at least one embodiment, an entertainment device may be configured to receive communications from other users in a joint viewing session but may or may not be configured to also receive and/or transmit such communications.

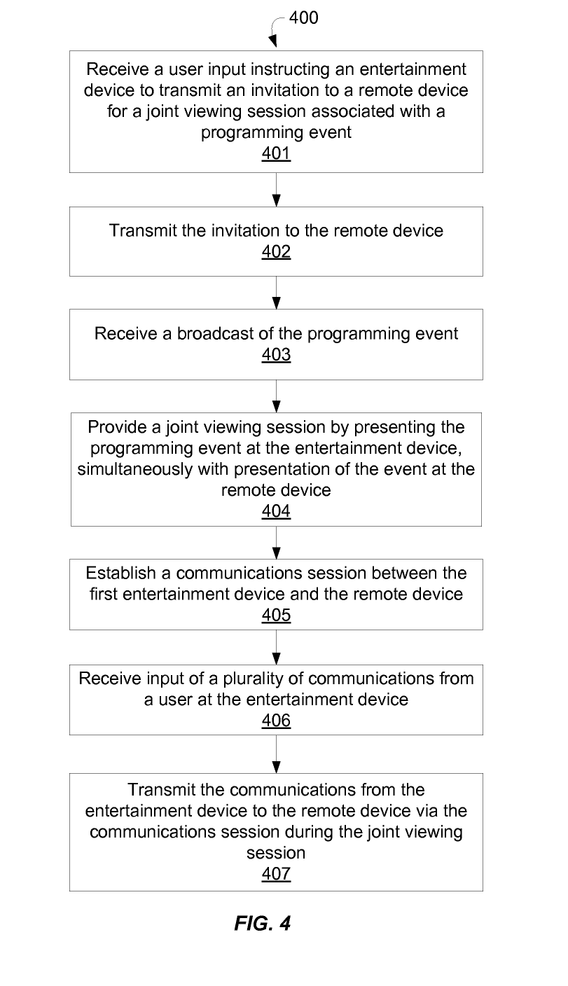

FIG. 4 provides a flow chart of an example embodiment of a process for implementing a joint viewing session. First, an entertainment device receives a user input instructing the device to transmit an invitation to a remote device for a joint viewing session associated with a programming event (operation 401). In some embodiments, the remote device may be a second entertainment device, or may be a communications device such as a smart phone, tablet, laptop, PDA, desktop computer, or other communications device. Second, the invitation is transmitted to the remote device (operation 402). Third, a broadcast of the programming event is received (operation 403). Next, a joint session is provided by presenting the programming event at the entertainment device, simultaneously with presentation of the event at the remote device (operation 404). The programming event may be received and presented by each device, or in some embodiments, one or more of the operations may be facilitated by a media server, as described above. A communications session is established between the first entertainment device and the remote device (operation 405). The entertainment device receives input of communications from one or more users of the device (operation 406). The communications are then transmitted from the entertainment device to the remote device via the communications session during the joint viewing session (operation 407). In at least one embodiment, a media server may facilitate the communications session and relay communications between the two or more devices participating in a joint viewing session.

Although specific embodiments were described herein, the scope of the invention is not limited to those specific embodiments. The scope of the invention is defined by the following claims and any equivalents therein.

1. A method, comprising:
receiving, at a first entertainment device, a user input from a first user instructing the first entertainment device to transmit an invitation to a second entertainment device that corresponds to a second user, the invitation associated with a programming event;
transmitting the invitation to the second entertainment device;
receiving a broadcast of the programming event at the first entertainment device;
presenting the programming event at a first display device corresponding to the first entertainment device, wherein the programming event is presented simultaneously with a presentation of the programming event by the second entertainment device;
establishing a communications session between the first entertainment device and the second entertainment device during at least a portion of the simultaneous presentation of the programming event;
receiving, at the first entertainment device, an input of a plurality of communications from the first user of the first entertainment device; and
transmitting the plurality of communications from the first entertainment device to the second entertainment device via the communications session, wherein the communications are presented to the second user at the second entertainment device during the presentation of the programming event at the second entertainment device.

2. The method of claim 1, further comprising:
receiving, at the first entertainment device via the communications session, a plurality of communications from the second user of the second entertainment device during the presentation of the programming event; and
presenting the plurality of communications to the first user at the first display device simultaneously with the presentation of the programming event at the first display device.

3. The method of claim 2, wherein the plurality of communications received at the first entertainment device from the first user comprise textual data that is input to the first entertainment device by the first user via a textual input device.

4. The method of claim 2, wherein the plurality of communications received at the first entertainment device from the first user comprise audio communications from the first user that are recorded by an audio input device that is coupled to the first entertainment device.

5. The method of claim 4, wherein the plurality of communications received at the first entertainment device from the first user further comprise video communications, which are captured by a video input device.

6. The method of claim 5, wherein the video and audio communications are transmitted to the second entertainment device and are presented thereon in real-time, simultaneously with the presentation of the programming event.

7. The method of claim 1, further comprising:
presenting the programming event at the first display device in real-time as it is received at the first entertainment device, wherein the programming event is presented at the first entertainment device simultaneously with a presentation of the programming event at the second display device in real-time as it is received.

8. The method of claim 1, wherein the invitation corresponds to a future viewing time for the programming event, which is subsequent to a broadcast time of the programming event, the method further comprising:
recording the programming event at the first entertainment device during the broadcast time of the programming event, wherein presenting the programming event at the first display device comprises presenting the recorded programming event at the future viewing time, the future viewing time corresponding to a simultaneously scheduled presentation of a recorded instance of the programming event at the second entertainment device.

9. An entertainment device, comprising:
a user input interface that receives a user input from a first user instructing the entertainment device to transmit an invitation corresponding to a future joint viewing session to a second entertainment device, the invitation specifying a future viewing time for the joint viewing session and a programming event that will be presented during the joint viewing session;
a processor that sets a calendar item at the entertainment device, the calendar item corresponding to the viewing time at the entertainment device;
a communications interface that transmits the invitation to the second entertainment device via the communications network, wherein a calendar item is set at the second entertainment device corresponding to the future viewing time for the joint viewing session;
a receiving interface that receives a transmission of the programming event from a content source; and
a presentation interface, which presents the programming event at the presentation device during the joint viewing session, wherein the programming event is presented at the first entertainment device at the same time as it is presented at the second entertainment device;
the user input interface receiving a plurality of communications from the first user;
the communications interface transmitting the plurality of communications received from the first user of the first entertainment device to the second entertainment device via a communications network during at least a portion of the presentation of the programming event.

10. The entertainment device of claim 9, wherein the entertainment device is in a geographically separate location from the second entertainment device.

11. The entertainment device of claim 9, further comprising:
a user input interface that receives a user input from a first user instructing the entertainment device to transmit the invitation corresponding to the future joint viewing session to a third entertainment device;
the communications interface sending information regarding the scheduled future viewing time to a communications device, wherein the communications device processes the information in order to set a calendar event corresponding to the future viewing time.

12. The entertainment device of claim 9, wherein the entertainment device automatically begins presentation of the programming event at the viewing time corresponding to the joint viewing session.

13. The entertainment device of claim 11, further comprising:
a processor that records the programming event in a non-volatile memory as it is received by the receiving interface; wherein the programming event is played back from the non-volatile memory at the viewing time corresponding to the joint viewing session, and the viewing time is later than the time when the programming event is received and recorded, the joint viewing session corresponding to a simultaneous playback of a recorded instance of programming event at the second entertainment device.

14. The entertainment device of claim 13, further comprising:
the communications interface receiving a plurality of communications from the second entertainment device during the joint viewing session; and
the presentation interface presenting the communications from the second entertainment device simultaneously with the programming event during the joint viewing session.

15. The entertainment device of claim 14, further comprising:
the communications interface receiving a plurality of communications from a third entertainment device;
the communications interface transmitting the invitation to the third entertainment device via the communications network, wherein a calendar item is set at the third entertainment device corresponding to the future viewing time for the joint viewing session;
the communications interface receiving a plurality of communications from the third entertainment device during the joint viewing session; and
the presentation interface presenting the communications from the third entertainment device simultaneously with the programming event during the joint viewing session.

16. An entertainment device, comprising:
a presentation interface that presents to a user of the entertainment device a graphical representation of a programming schedule corresponding to a plurality of future programming events that are scheduled to be broadcast at corresponding future broadcast times via a distribution network;
a user input interface that receives a selection, from an input device of the user, of a future programming event from the programming schedule and that receives a corresponding input instructing the entertainment device to send an invitation to a remote device associated with a second user, the invitation specifying the programming event, a viewing time for presenting the programming event, and a request for the user of the remote device to participate in a viewing session of the programming event with the user of the entertainment device at the viewing time; and
a processor that sets a calendar event at the entertainment device corresponding to the viewing time for presenting the programming event;
a communications interface that transmits the invitation to the remote device associated with the second user, wherein the remote device sets a calendar event corresponding to the viewing time for presenting the programming event;
a receiving interface that receives the programming event during a scheduled broadcast time; and
a presentation interface that presents the programming event at the viewing time in order to facilitate the joint viewing session.

17. The entertainment device of claim 15, wherein the invitation comprises an invitation to view the programming event in person with the user at the entertainment device at the viewing time.

18. The entertainment device of claim 16, wherein the remote device comprises a second entertainment device corresponding to the second user, which is at a separate location from the first entertainment device.

19. The entertainment device of claim 18, wherein the viewing session comprises a virtual joint viewing session, wherein the invitation is operable to cause the second entertainment device to remotely present the programming event at the viewing time, further comprising:
the user input interface receiving communications from the first user during the virtual joint viewing session; and
the communications interface transmitting the communications to the second entertainment device during the virtual joint viewing session.

20. The entertainment device of claim 19, wherein the viewing time is later than a broadcast time of the programming event, further comprising:
a processor that records the programming event during the scheduled broadcast time as it is received by the receiving interface; and
the presentation interface presenting the recorded programming event at the viewing time, wherein the invitation is operable to be processed by the second entertainment device such that the second entertainment device records the programming event during the scheduled broadcast time and participates in the virtual joint viewing session of the programming event by presenting the recorded instance of the programming event at the viewing time specified by the invitation.
